(19) United States
(12) Patent Application Publication
(10) Pub. No.: US 2006/0146118 A1
(43) Pub. Date: Jul. 6, 2006

(54) Laser printer and method of using same

(75) Inventor: Edmond Abergel, Paris (FR)

Correspondence Address: LOWE HAUPTMAN BERNER, LLP, 1700 DIAGONAL ROAD, SUITE 300, ALEXANDRIA, VA, 22314, US

(73) Assignee: MGI France, Ivry sur Seine (FR)

(21) Appl. No.: 11/315,597

(22) Filed: Dec. 23, 2005

(30) Foreign Application Priority Data
Dec. 24, 2004 (FR) 04 13875

(51) Int. Cl. B41J 2/47; B41J 2/435

(52) U.S. Cl. 347/232

(57) ABSTRACT

A digital laser printer that prints onto a plastic or paper substrate, includes a laser engine managed by a control card and a software application, to provide: continuous control of fuser oven temperature in accordance with fuser oven temperature, as measured continuously during printing; continuous control of pressure roller temperature in accordance with roller temperature, as measured during both printing and non-printing phases, in relation to setpoints established in according to the substrate and the printing or non-printing phases, control of the pressure applied by the pressure roller to the substrate in response to continuous measurement of roller pressure, control of substrate speed during its movement through the printer, and to vary the temperatures and pressures in accordance with the controlled substrate speed measured, and control of the voltage of a dispenser that transfers toner to the substrate.

### RELATED APPLICATIONS

The present application is based on, and claims priority to, French Application Serial Number 04 13875, filed Dec. 24, 2004, the disclosure of which is hereby incorporated by reference herein in its entirety.

### FIELD OF THE INVENTION

The present invention relates to laser printers and methods of using same.

### BACKGROUND ART

Certain technical and economic problems arise when using conventional laser printers on plastic and certain paper substrates. Some of the difficulties when laser printing onto plastic, and particularly onto PVC, are:

non-deformation of the medium,

achieving adequate adherence of the toner on the support,

creating a product with no overlay,

achieving good positioning of the print, with good repeatability.

### SUMMARY OF THE INVENTION

This solution includes equipment which is associated with a process for the production, using digital printing with powder ink (toner), of documents with no overlay, on PVC or on any other plastic or paper substrate, with excellent control of the print position.

One application that can be envisaged, amongst others, can be the production of plastic bank cards with or with no electronic chip, or indeed of identity cards, driving licences, etc.

The plastic PVC sheets or cards are generally printed by the offset technique, by screen printing, or more recently by a digital laser technique on plastic media other than PVC.

This printing is most frequently effected on sheets that are assembled to enable double-sided printing to produce the final document, to which is added, on the recto and verso sides, a transparent top protective layer (an overlay), usually in PVC.

This stack thus formed is placed in a press, and a temperature and pressure cycle is then executed in order to attach the overlay.

These sheets are then used in their printed form or cut to obtain cards or objects of the desired shape.

An object of the invention is to achieve, in an economic manner particularly for small or medium print runs, the production of plastic documents presenting graphical information, and possibly to customise these with a digital printing laser so as to allow a high degree of flexibility regarding the customising data. The invention therefore uses the technique of laser printing with a powder toner, irrespective of the substrate, even with PVC which does not readily tolerate the printing temperatures normally used for other plastics. Furthermore, the invention aims to obtain very good adherence of the ink onto PVC or onto another substrate without necessarily resorting to a protective overlay.

This objective is met is by a digital laser printing technique for documents printed on any plastic or paper substrate, and includes a print engine preferably commanded by a control card and a software application to provide:

continuous control of the temperature of the print engine fuser oven during the printing phases, according to the continuously measured temperature,

continuous control of the temperature of the pressure roller, during the printing and non-printing phases, according to the measured temperature of the latter, in relation to setpoints established as a function of the substrate and the printing or non-printing phases,

control of the pressure applied to the substrate by the pressure roller, and to continuously measure this pressure,

control of the speed of motion of the substrate and to adapt the temperatures and pressures to the measured speed, and

measuring the voltage of the dispenser for transferring the toner onto the substrate.

According to another particular feature, the print engine includes, in the software application, a table which specifies, according to the type of substrate, the setpoint temperatures of the fuser oven and of the pressure roller, the pressure to be applied by the pressure roller, the heating boosts to be applied at the start of the printing process, the heat control during printing once the substrate has risen in temperature, and the control voltage of the transfer device to suit the substrate.

According to another particular feature, the software application includes resources that allow a user, through an interactive interface, to select the type of substrate used for the pressure, and thus to determine the operating conditions of the print engine in accordance with the table stored by the software.

According to another particular feature, the printer includes several sheet feeder systems and a system to effect the electrostatic discharge of substrate sheets.

According to another particular feature, at the output of the print engine, a temperature and a pressure are applied to the printed substrate in order to glaze the ink in the substrate, especially in the case of PVC substrates.

According to another particular feature, the regulation resources of the control card employ pulse width modulation to control the temperature of the fuser oven, the print roller and the toner transfer device.

A second objective of the invention is to propose a document printing process on any paper or plastic substrate using the printer according to the invention.

This objective is met by a process that is characterised in that it includes at least the following steps:

preparation of a computer file which determines the image to be printed, and customised or non, on the substrate,

printing of the image on the substrate by the digital laser printer,

application of pressure and temperature to the printed substrate as a function of speed of said substrate so as to achieve glazing of the ink deposited on the substrate.

The final product obtained therefore has no overlay.

According to another particular feature, after the application of pressure and temperature, the process includes a stage for cutting of the product obtained to the desired format, and possibly a stage of customisation by thermal transfer or other printing resource, and a stage for the application of pressure, or of pressure and temperature, to affix a protective overlay onto the product.

According to another particular feature, the laminated card is cut to the format of an ISO card.

According to another particular feature, the substrate printed on one face is assembled to another substrate so as to obtain a final product that is printed on both sides and with a determined thickness, by attaching the two substrates by their unprinted sides, and then this assembly is placed between two sheets of different materials, and laminated with a controlled pressure and temperature so as to achieve a stack of substrates.

This step can also be used to ensure excellent accuracy of the print position, and to achieve double-sided printing, on PVC products in particular.

### BRIEF DESCRIPTION OF THE DRAWINGS

Other particular features and advantages of this present invention will appear more clearly on reading the following description, provided with reference to the appended drawings, in which:

FIG. 1 represents the subassemblies making up the printer.

FIG. 2 represents the placement of printed material onto a medium.

FIG. 3 represents preparation for the purpose of lamination.

FIG. 4 represents the product after lamination.

FIG. 5 represents the subassemblies of the printer.

FIG. 6 represents the various mechanisms of the printer.

FIG. 7 represents the control card.

FIG. 8 represents the functional block diagram for the temperature and pressure control setpoints.

FIG. 9 represents the functional block diagram for control of the voltage for fixing the toner onto the substrate.

### DETAILED DESCRIPTION OF THE DRAWINGS

The sheets to be printed are placed in the feeder (1 in FIG. 1), which, for example, can have a capacity of several thousand sheets with a maximum size of 350×500 mm, and with a thickness of between 80 and 300 μm.

The sheets are taken from the top of the stack by a suction device (not shown) and inserted into a feed track to the printer.

This feed track then inserts the sheets into a feeder (2 in FIG. 1) in order to position them in relation to a reference edge which is, for example, the left side of the substrate in its direction of travel.

Checks such as the presence of the substrate and the detection of double sheets are performed by sensors located in this feeder.

As an option, an ionised-air blowing device (not shown) is placed between the output of the feeder (2) and the input of the laser printer (3). The purpose of this is to control the electrostatic charges on the substrate used.

The engine of the laser printer (3), of the colour type, for example, is a commercially purchased product which can print several thousand pages per hour. The printer uses a toner (a powder ink composed from an acrylic styrene resin), and the various mechanisms of the printer include a print engine (30 in FIG. 6), a heating system (F in FIG. 6), a device for ejection of the sheets, which are controlled by a computer system (5) of the PC type or any other computer.

This computer system is used to format files, images, graphics or customising data, and to manage the toner transfer rates and the temperature and pressure on the substrate according to the nature of the latter. This management or control process is a particular feature of this innovation, which allows printing particularly onto substrates that have a very low vikat point, such as PVC for example.

The printed documents are collected in an out tray (4).

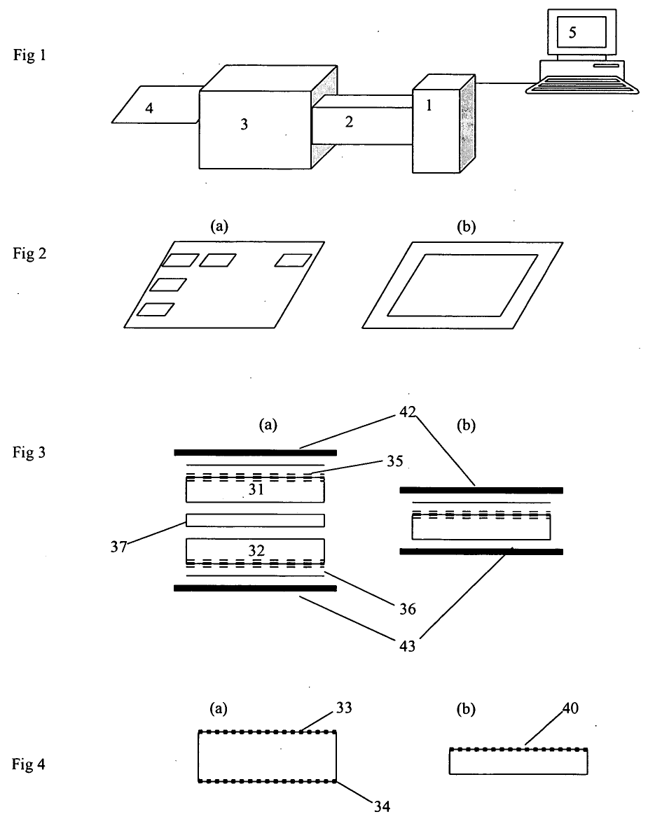

FIGS. 2 (a) and (b) represent the possible arrangements of the print on the substrate. FIG. 2 (a) shows the image positions, which can be as many as 21 or more in the case where the invention is applied to the production of cards in ISO formats.

One of the particular features of digital printing is that it can be used to obtain prints of variable and modifiable material onto the medium, so as to allow the printing of documents like identity cards, driving licences, bank cards, health-record cards, electronic purse cards, loyalty cards, etc., on any given support.

FIG. 2 (b) represents a full-page print arrangement, possibly used for advertising pages or posters.

FIG. 3 illustrates the stacking of substrates with a view to lamination by the application of pressure and/or temperature to the substrate, or to a stack of several printed substrates.

FIG. 3 (a) shows a stack which can be used, for example, to produce cards in the ISO format.

The substrates (31, 32) printed on a single face, form the recto (35) and verso (36) sides of the card respectively. An intermediate substrate (37), which is pre-affixed or of such a nature as to bring about welding or adherence during lamination, can be inserted between the two sheets joined together by their unprinted faces.

By virtue of its determined thickness, this intermediate substrate (37) can be used to obtain a product of the desired thickness after lamination.

This operation of laminating the printed substrate results in glazing of the toner (33, 34, 40 in FIG. 4).

FIG. 3 (b) represents construction with a single printed substrate.

Following this lamination procedure, we obtain substrates which are printed with glazed ink and with no overlay, the recto verso case of FIG. 4 (a) and with only one printed face as shown in FIG. 4 (b).

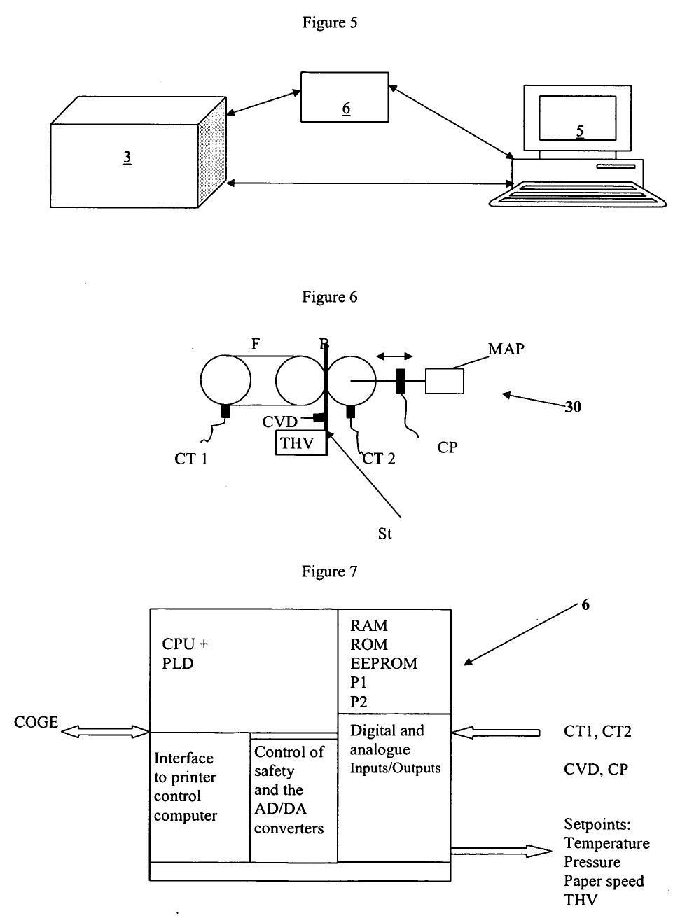

To allow the implementation of the invention, the operation of a colour printing laser engine (3 in FIG. 5) has been modified so that it can be driven by a control card (6) in dialogue with the control computer (5), which sends the printing commands to the print engine (3). As shown schematically in FIG. 6, the print engine (30) of a laser printer (3) is composed of a device (THV) which effects transfer of the toner powder to the substrate (St), of a motion speed sensor (CVD) measuring the speed of movement of the substrate (St), and an fuser oven (F) which generally is a device composed of 2 fixed rollers driving a band whose temperature is monitored by a temperature sensor (CT1). A second pressure or backing roller (B) is applied with pressure to one of the two rollers of the fuser oven, and its temperature is controlled by a control loop using the measurements made by a sensor (CT2). The pressure applied to substrate (St) by roller (B) is adjusted by a pressure adjusting motor (MAP). A pressure control loop is created by means of a pressure sensor (CP) placed in the thrust axis of the pressure roller (B), controlled by the pressure motor (MAP).

In order to be able to print with a print engine such as that described above, on many types of plastic or paper substrates, and especially on PVC, and in order to achieve adherence of the print so that the printed substrate can be used either with or without an overlay, the control card has to take action in the following areas:

managing the temperature of the fuser oven (F) with optimisation during the periods when not printing,

managing the voltage (THV) for fixing of the toner onto the substrate,

managing the pressure applied by the backing roller (B) during pressure application,

managing the rate of introduction of sheets, by monitoring the motion speed sensor CVD.

The control card acting in the above circumstances is made up as shown in FIG. 7, by combining a microcontroller with programmable logic circuit (PLD). The purpose of this programmable logic circuit (PLD) is to provide the management resources of the microprocessor, namely RAM/ROM memory, inputs/outputs, management of the inputs/outputs of the process, management of analogue-digital and digital-analogue converters, employed to convert, firstly, the signals delivered by the temperature and speed of movement sensors and, secondly, to convert the digital setpoints into analogue commands, logic for management of the EEPROM and of the safety functions. This control card (6) is interfaced with the control computer of the printer over a connection of the Ethernet or RS232 or USB type, or any other communication resource, and communicates with the printer through analogue and digital inputs and outputs.

Temperature control, effected by the card (6), mainly concerns the electrical power supply of the fuser oven (F) and of the compression backing roller (B), and their respective temperature sensors or probes (CT1, CT2) and further said motion speed sensor (CVD).

The motion speed sensor (CVD) provides an electric signal representative of the speed of motion of the substrate. The electric signal representative of the speed of motion of the substrate is transformed into digital information representative of the speed of motion by an analog-to-digital converter of the control card (6). The digital information representative of the speed of motion is transmitted to a control computer (5) by the control card (6). A processing of the digital information representative of the speed of motion is realized by the control computer (5) so as to determine temperature setpoints to be applied.

The method chosen to manage the baking temperature of the toner consists of continuously controlling the regulation temperature of the fuser oven (F) of the machine by continuously adapting the setpoint temperature.

This temperature is held and corrected continuously during printing of the substrate, and also during the intervals between the printing phases.

This adaptation of temperature consists of offsetting the control graph by the addition of an offset value to increase or reduce the heating power. This offset value will be a function of the medium to be printed and the state of advancement of the printing onto the substrate, while also controlling the temperature of the machine, the safety features and the progressive change of setpoint.

Variations of setpoint will be progressive and consistent with the times required to heat or cool the engine (30) of the printer.

Thus, when the entry of a substrate is detected in the printer, it will be desirable to raise the planned setpoint for the type of substrate concerned by a power-boost offset value to compensate for the losses due to absorption by the substrate, and then, as measurements indicate a rise in the temperature of the substrate, to lower the setpoint, or even to apply a power reduction offset in order to prevent the softening point of the substrate being reached.

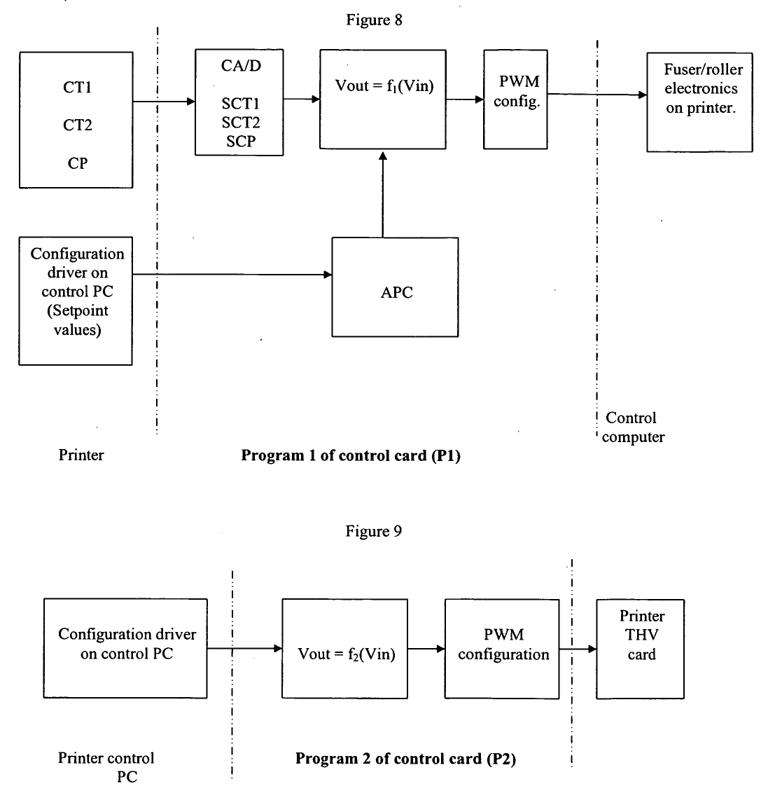

The functional block diagram for each temperature control setpoint is that shown in FIG. 8, and repeated for each temperature regulation line, namely for the fuser oven (F) and for the backing pressure roller (B).

The measurement signals of the temperature sensors (CT1, CT2) of the fuser oven or the backing roller respectively are transmitted in analogue form to the analogue-digital converter, which converts them into digital signals that are then processed by the transfer function of the control card (6), thus to determine a control signal Vout, which in its turn is applied to a digital-analogue converter, to constitute the control setpoint applied to the electronics of the fuser oven or the backing roller of the print engine (30). A program for configuration of the value of setpoints to be applied to the fuser oven or the backing roller, executed on the control computer (5), allows the delivery of setpoints, which are then processed by a function for progressive adjustment of the setpoint in order to modify the transfer function (f1). Program (P1) on the control card (6) operates the analogue digital converters and the transfer function, as well as the function for progressive adjustment of the setpoint. Two programs are thus employed, one for control of the fuser oven, and the other for control of the backing roller.

During the periods between the printing phases, the program (P1) on the card (6) performs optimisation of the temperature regulation of the fuser oven, by continuously supplying power to the compression backing roller (B) to compensate for its power losses.

This power will also be supplied during the periods in which the fuser oven is not being heated and regulated in accordance with these losses. This limitation is dependent in the medium to be printed and on the print periods.

The temperature control setpoint of the fuser oven (F) is analysed by the program (P1) and during a non-heating period it is the backing pressure roller (B) which is supplied with a command of the pulse width modulation PWM type, thus limiting the power supplied to the engine (3) to that strictly necessary.

As can be seen by reference to table T1, the heating cycle time can be configured according to the medium used and the current machine cycle (printing of the substrate or waiting to print).

A second table T2 contains ranges of temperatures applied to the substrate as a function of the speed of motion of the substrate. A temperature range for the oven (F) is determined by a minimal temperature (Temp. Fuser min.) of the oven and a maximal temperature (Temp. Fuser max.) of the oven (F). A temperature range for the pressure roller (B) is determined by a minimal temperature (Temp. Backup min.) of the pressure roller and a maximal temperature (Temp. Backup max.) of the pressure roller (B). A speed range for the substrate (St) is determined by a minimal speed (CVD min) of the substrate and a maximal speed (CVD max) of the substrate (St). When detection means (6) detect increase of the speed of the substrate, that implies increase of the temperature setpoints calculated by the control computer (5).

The functional block diagram for management of the voltage employed to fix the toner onto the sheet THV is shown in FIG. 9.

The THV (High-voltage level) is adjusted by adapting the pulse width (PWM) of the voltage generator.

The method chosen consists of adjusting the width according to the type of medium to be printed (see configuration table T1 below).

The THV value is generated by the machine control computer (5) by means of table T1, stored in the computer, and giving the values of the setpoint parameters according to the substrate employed.

The pressure applied by the backing roller (B) onto the toner is controlled by a sensor CP and adjusted by a motor (MAP) operating a pressure spring on the roller (B) as a function of pressure parameters specified to suit the substrate used.

This pressure is a function of the type of substrate introduced into the printer.

Parameter configuration concerns the setpoints specified in a table in the control computer (5). The setpoints concerned are as follows:

Temperature of the fuser oven (Ci),

Temperature of the backing roller (C′i),

Heat distribution when printing (%i),

Heat distribution when not printing (%′i),

Voltage setpoint (Ui),

Pressure on the substrate (Pi).

The various setpoints are dependent upon the different types of substrates used.

The choice is made by the operator on the control computer, using an interactive interface that allows him to specify the type of substrate used for the print run, at the start of the run.

In table T1, shown below in the appendix, the setpoints are represented by the symbols Ci, C′i, Ui, Pi, and the positive or negative heating offset values by % i.

In table T2, shown below in the appendix, the range limits are represented by the symbols θi, θ′i, Bi, B′i, Si and S′i.

It will be obvious to those skilled in the art that this present invention can be implemented in many other specific forms without going outside of the area of application of the invention as claimed. As a consequence, the methods of implementation described here must be considered as given by way of illustration only, and can be modified within the area defined by the scope of the attached claims.

### APPENDIX

TABLE T1

| | Temper- | | Heat | Heat | | |
|---|---|---|---|---|---|---|
| | ature | Temperature | applied | applied | | |
| Type of | of fuser | of backing | when | when not | | Pres- |
| substrate | oven | roller | printing | printing | THV | sure |
| 80 g paper | C1 | C′1 | %1 | %′1 | U1 | P1 |
| Card | C2 | C′2 | %2 | %′2 | U2 | P2 |
| PVC | C3 | C′3 | %3 | %′3 | U3 | P3 |
| PET | C4 | C′4 | %4 | %′4 | U4 | P4 |
| Polycar- | C5 | C′5 | %5 | %′5 | U5 | P5 |
| bonate | | | | | | |
| PC-ABS | C6 | C′6 | %6 | %′6 | U6 | P6 |
| Other | Ci | C′i | % i | % ′i | Ui | Pi |
| substrates | | | | | | |
| etc. | | | | | | |

TABLE T2

| | Fuser | Fuser | Backup | Backup | | |
|---|---|---|---|---|---|---|
| Type of | Temp. | Temp. | Temp. | Temp. | CVD | CVD |
| substrate | min. | max. | min. | max. | min. | max. |
| 80 g paper | θ1 | θ′1 | B1 | B′1 | S1 | S′1 |
| Card | θ2 | θ′2 | B2 | B′2 | S2 | S′2 |
| PVC | θ3 | θ′3 | B3 | B′3 | S3 | S′3 |
| PET | θ4 | θ′4 | B4 | B′4 | S4 | S′4 |
| Polycar- | θ5 | θ′5 | B5 | B′5 | S5 | S′5 |
| bonate | | | | | | |
| PC-ABS | θ6 | θ′6 | B6 | B′6 | S6 | S′6 |
| Other | θi | θ′i | Bi | B′i | Si | S′i |
| substrates | | | | | | |
| etc. | | | | | | |

1. A laser printer capable of printing onto substrates of different materials, including a fuser oven, a pressure roller, a transport system for moving the substrates through the fuser oven and the pressure roller, a toner dispenser having a voltage source for controlling fixation of toner to the substrate, and a controller arranged:
(a) for continuously controlling the temperature of the fuser oven in accordance with a continuous indication of the temperature of the oven during a printing phase,
(b) for continuously controlling, during both printing and non-printing phases, the temperature of the pressure roller according to an indication of the temperature of the latter, in relation to setpoints established as a function of the substrate material and whether the printer is in the printing phase or non-printing phase,
(c) for controlling the pressure applied by the pressure roller to the substrate in response to an indication of a continuous measure of the roller pressure,
(d) for controlling the speed of movement of the substrate through the printer and to adapt at least one of the temperatures and the pressure according to an indication fo the substrate speed, and
(e) for measuring and adapting the voltage of the toner dispnser for transferring the toner to the substrate.

2. The device of claim 1 wherein the controller includes a table which specifies, according to the type of substrate used: setpoint temperatures of the fuser oven and the pressure roller, the pressure to be applied by the pressure roller, heat-boosting offsets to be applied at the start of printing, and heat reductions to be applied during printing once the substrate has risen in temperature, and the control voltage of the dispenser, to suit the substrate used.

3. The device of claim 2, wherein the controller includes resources for enabling a user, through an interactive interface, to select the type of substrate used, and thus to determine the operating conditions of the printer in accordance with the table.

4. The device of claim 1, further including an arrangement for performing electrostatic discharging of the substrates.

5. The device of claim 1, further including a heat and pressure applicator at the output of the laser printer for applying heat and pressure to the printed substrate to glaze the ink on the substrate.

6. The device of claim 5, further including a cutter for the substrate downstream of the heat and pressure applicator, and an overlay applicator for the cut substrate downstream of the cutter.

7. The device of claim 1 wherein the controller includes a pulse width modulation arrangement for controlling the temperature of the fuser oven, the print roller and the toner dispenser.

8. A document printing process for a paper or plastic substrate using the laser printer according to claim 1, including at least the following steps:
preparation of a computer file that determines the image to be printed onto the substrate,
printing of the image onto the substrate by the laser printer,
application of pressure and temperature onto the printed substrate, in accordance with the speed of said substrate, so as to glaze the ink deposited on the substrate.

9. The process of claim 8 further including formating a laminated card by (a) applying an overlay to the substrate after the ink has been glazed and (b) then cutting the substrate to the format of an ISO card.

10. The process of claim 8 further including assembling the printed substrate with another substrate to obtain a final product of a determined thickness printed on both exterior sides, by joining the two substrates and then placing the two joined substrates between two sheets of different materials, and then laminating the two substrates and two sheets with a controlled pressure and temperature to achieve stacking of the substrates.

11. A method of printing onto a substrate by using a fuser oven, a pressure roller, a transport system for moving the substrate through the fuser oven and the pressure roller, a toner dispenser having a voltage source for controlling fixation of toner to the substrate, the method comprising:
(a) continuously controlling the temperature of the fuser oven in accordance with a continuous indication of the temperature of the oven during a printing phase.
(b) continuously controlling, during both printing and non-printing phases, the temperature of the pressure roller according to an indication of the temperature of the latter, in relation to setpoints established as a function of the substrate material and whether the printer is in the printing phase or non-printing phase.
(c) controlling the pressure applied by the pressure roller to the substrate in response to an indication of a continuous measure of the roller pressure,
(d) controlling the speed of movement of the substrate through the printer and adapting at least one of the temperatures and the pressure according to an indication fo the substrate speed, and
(e) measuring and adapting the voltage of the toner dispenser for transferring the toner to the substrate.

12. The method of claim 11 wherein the substrate is plastic.
